(19) United States
(12) Patent Application Publication
(10) Pub. No.: US 2007/0078018 A1
(43) Pub. Date: Apr. 5, 2007

(54) Golf range with automated ranging system

(76) Inventors: Norman Kellogg, Garden Grove, CA (US); Frank W. Mabry, Irvine, CA (US); Wayne Hom, Coto De Caza, CA (US)

Correspondence Address: DRUMMOND & DUCKWORTH, Suite 500, 4590 MacArthur Blvd., Newport Beach, CA, 92660, US

(21) Appl. No.: 11/487,049

(22) Filed: Jul. 14, 2006

Related U.S. Application Data
(60) Provisional application No. 60/722,319, filed on Sep. 30, 2005.

(51) Int. Cl. A63B 69/36

(52) U.S. Cl. 473/151; 473/168; 473/155; 473/154

(57) ABSTRACT

An automatic golf ball ranging system is provided for retrofitting existing passive golf ranges to include an electronic system for notifying golfers as to the distance between the impact of their golf ball on the range and the golfer's target. The automated golf ranging system includes a pod which is preferably self contained to include an independent power supply, one or more microphones for receiving the sound of a golf ball impacting the golf range, a processor for processing the sound made by the golf ball, and visual or audio indicators for providing feedback to the golfer. The processor performs modification, filtration and analysis of the amplitude of the ball impacting the golf range to estimate the distance between golf ball impact and target. In preferred embodiments, the processor filters out ambient background noise and the processor automatically adjusts itself to changing ambient sound levels. Preferably, the processor also considers the time duration of the sound of a golf ball impacting the range when estimating the distance between golf ball impact and target.

This Application is a Continuation-in-Part of U.S. Provisional Application No. 60/722,319, filed on Sep. 30, 2005.

### BACKGROUND OF THE INVENTION

The present invention relates to golf ranges and targeting systems. More particularly, the present invention relates to a method and apparatus for providing golfers at a golf range with ranging information which is the distance between the landing of their golf balls and a target such as an upright flag.

The impact location of a projectile is of interest in a number of different fields, from military to sports. Unfortunately, previous attempts to track projectile impacts, particularly for tracking the impacts of sports projectiles such as golf balls, has been ineffective or too expensive. The traditional golf driving or chipping range traditionally allows golfers to rent a bucket of balls which a golfer then propels from a t-stand using a golf club. The balls are typically hit from the t-stand on to the golf range which is normally equipped with markers that numerically indicate the distance from the t-stand. These numerical markers enable the golfer to estimate the length of his drive or chip. The golfer's ability to estimate the length of his drive or chip is dependent upon his ability to follow the path of his golf ball and to see the golf ball's lie, the actual spot where the ball lands after being hit.

As an alternative to numerical range markers, golf ranges and chipping ranges will often include flag staffs which are intended to mimic a golf green. Golfer's strike the ball attempting to land the golf ball within a few feet of the “pin”. Again, the golfer's ability to judge the distance or location of his drive or chip is dependent upon his eyesight.

Traditional driving or chipping ranges are configured with the t-stands or stalls located on one side of a field. Distance markers and flags are measured perpendicular from the line of golfers with the farthest markers generally about 300 yards from the t-stand. Since the markers indicate distances that are perpendicular to the t-stands, these numerical indicators are only accurate for balls hit in the direction perpendicular to the tees. Unfortunately, the numerical indicators are not accurate for golf balls that are struck at an angle to the tee, as the golf balls that travel either to the left or right actually travel farther than indicated by the numerical markers. Therefore, traditional golf ranging systems do not even provide an accurate indication of the length of a golfer's drive, let alone its accuracy.

There have been various attempts to provide an improved indication as to the accuracy of balls struck at a golf range. For example, some installations have added permanent targets placed indiscriminately around the range. These targets are designed similar to skeet ball targets in that they include concentric rings with drainage holes for collection. In some installations, golf balls can be read as they pass underground through a drainage system. The readings are then provided to the golfer as range estimates or as “scores” as the golfer hits balls into the rings.

There have been a variety of attempts to provide distance measurements between the landing of a golf ball and a target. For example, U.S. Pat. No. 5,393,064 describes a golf range which has a plurality of microphones placed around the target area. The sound of a golf ball landing is received by the plurality of microphones, and a processor uses triangulation measurements to estimate the golf ball's range. Unfortunately, this system requires substantial retrofitting of an existing golf range and placement of numerous microphones at various places.

U.S. Pat. No. 4,045,023 also describes a golf range including a plurality of microphones. A first microphone measures the time the golf club strikes the golf ball while a second microphone measures the time of golf ball impact upon the golf range. These times are processed to measure distance and accuracy to provide a score which is shown on a scoreboard. Meanwhile, U.S. Pat. Nos. 3,643,959 and 5,478,077 describes golf training aids which are primarily used indoors. The devices employ microphones which determine when a ball has been struck. Information is then processed to determine projected distance and accuracy.

Recently, it has been proposed to provide golf balls with RFID's and the golf range with a plurality of transceivers. Upon the golf ball landing within the vicinity of a transceiver, location or range is estimated and then provided to the golfer.

Unfortunately, the aforementioned systems have been inherently inaccurate or unduly costly. Therefore, there is a significant need for a ranging system that estimates the distance between the landing of a golf ball and a target.

There is also a need for a golf ball ranging system which is inexpensive to manufacture and install.

Furthermore, there is a need for a golf ball ranging system which does not require substantial modifications to an existing golf range.

### SUMMARY OF THE INVENTION

Briefly, in accordance with the invention, a golf ranging system is provided for estimating the distance between the landing of a golf ball and a target.

Conventional driving and chipping ranges are traditionally configured with t-stands or stalls located in a straight line. Adjacent to the t-stands is a broad expanse of land, preferably covered with grass. The golf ranges usually include one or more targets, typically in the form of flags mounted on top of staffs. Advantageously, this traditional golf range construction does not need to be modified for incorporation of the ranging system of the present invention. Instead, the golf ranging system includes one or more mobile pods which are located as desired on the golf range. The pods function either as the target or are positioned immediately adjacent to the target. Preferably the target is a traditional flag mounted upon a vertical staff, and the pod is positioned at its base.

Preferably the pod is mobile and self-contained including all the necessary power and electronics for determining the distance between a golf ball landing and a target. To this end, the pod includes a power source which may take the form of a hardwired electrical connection to a power grid. However, it is preferred that the power source comprise one or more mobile batteries which are carried within the pod's housing. One or more traditional 12 volt automobile batteries have been found to be satisfactory as a mobile power source. The power source is connected to one or more microphones and a processor. The term “processor” is intended to be interpreted broadly to include both hardware and software which modifies, filters and/or analyzes audio signals received from the one or more microphones.

The pod may include a single microphone. However, it is preferred that the pod include two, three, four or more microphones which are positioned equal distance around the pod's exterior. In the preferred embodiment, the pod includes twelve microphones which are positioned every 30 degrees around the pod's exterior for receiving sounds occurring from all directions around the pod. Preferably, each microphone is directional, and in the case where the pod includes twelve microphones, includes cone audio receivers having a spread of approximately 30 degrees.

Sounds received by the microphones are transmitted to the processor which may include both analog and digital processing circuits. The processor performs sound modification, filtration and analysis to determine an estimate as to the distance between a target and golf ball landing. More specifically, it has been found that the sound created by a golf ball striking the golf range surface, particularly grass, has distinctive sound characteristics. Typically, a golf ball landing creates sound at very low frequency ranges between 20 Hz. and 250 Hz. Further, the time period of a golf ball landing upon a range surface is typically greater than 0.005 seconds but less than 0.250 seconds. Accordingly, the processor of the present invention incorporates a band pass filter which removes audio signals less than 25 Hz. and greater than 250 Hz. In addition, the processor removes audio sounds having a length of less than 0.005 seconds and greater than 0.250 seconds. Preferably, the band-pass filters are incorporated in hardware in the form of inductor capacitor circuits. Meanwhile, it is preferred that the sounds of incompatible length be removed using software.

Additional audio signal processing may be done prior to analysis, such as signal amplification. Moreover, golf ranges often experience significant background noise, such as created by automobiles, airplanes or even crowds. Accordingly, it is preferred that the processor continuously detects and measures background noise and removes such noise prior to signal analysis. Moreover, typically the pod and microphones will receive sounds which still pass through all of the above-identified filters which are not caused by a golf ball landing in the vicinity of the pod. For example, the sound made by a golfer dropping his ball at the tee may still be received by the pod's microphones. However, since golfer's only desire the distance between ball and target after being struck, it is preferred that these audio signals also be removed. Accordingly, it is preferred that the audio processor establish a threshold for sounds above background ambient noise which should be processed. Though various thresholds can be established based upon environmental conditions, it has been found that a 10 decibel threshold above ambient background is acceptable for most environmental conditions.

Once the audio signals have been properly filtered and modified, the processor performs an analysis of the amplitude of audio signals produced by golf balls landing in the vicinity of the golf pod. Various types of measurements can be employed to estimate the distance from the golf ball landing to the pod. For example, a determination of peak amplitude of the sound of a golf ball landing alone can be used to estimate the distance between the golf ball landing to the pod, as the closer to the pod the greater the amplitude of the audio signal. However, it has been determined that greater accuracy can be obtained by the processor analyzing the sound's magnitude including the amplitude and the time duration of the sound of a golf ball landing on the range surface. To this end, the processor periodically takes amplitude measurements, preferably at rapid sample frequencies such as every 0.5 milliseconds. The amplitude measurements are obtained until audio signals are no longer received. Thereafter, the amplitude measurements are summed to provide the distance between the golf ball landing and the target. The summing of the amplitude measurements may include multiplying each amplitude measurement by the time period between readings which results in an estimate of the integral of amplitude with respect to time.

Based upon the summing of the amplitude measurements, the processor estimates the distance between the target and golf ball landing. For example, the greater the sum of the amplitude measurements indicates golf balls landing closer to the target. The processor may determine the distance in terms of feet, meters or simply as more subjective indications such as illustrated by demonstrative expressions or colorful lights. Demonstrative expressions may include “close to the pin”, “on the green”, “keep trying”, etc. Meanwhile, an infinite number of color schemes or brightness levels may be used to indicate to a golfer the accuracy of his shot. For example, green lights may indicate a closer shot that red lights, while flashing green lights may indicate a particularly exceptional shot.

To display the results to a golfer, the golf ranging system of the present invention includes a visual or audio indicator for notifying golfer's as to the accuracy of their golf shot. The visual or audio indicator may simply be a series of lights which are flashed from the pod itself. Alternatively, the ranging information can be transmitted to electronic systems located at the t-boxes for audio or visual production to the golfer. In preferred embodiments, the pod housing integrates a lighting system, preferably including energy efficient LEDs or the like, for displaying shot accuracy information to the golfer. By providing the visual indicators within the pod structure enables the pod to be self-contained and easily moved throughout the golf range.

Various modifications of the invention can be made. For example, the processor may periodically, randomly or selectively change the accuracy criteria for indicating the distance between golf ball landing and target. For example, a pod may be set up for novice golfers to indicate an exceptional shot at 40 feet of the target, while an expert pod may require a shot within 20 feet before providing a visual or audio indication of an exceptional shot. In an additional preferred embodiment of the invention, the pod may provide a visual or audio indication as to whether the pod is considered an “exceptional” target or “novice” target. Various indicators can be incorporated. For example, the pods may be outfitted with target flags of different colors to differentiate skill level. Alternatively, more easily changeable indicators may be incorporated such as colored lights or electronic signs.

In still additional preferred embodiments of the invention, the golf ranging system of the present invention may include two or more pods which are electrically connected. Sound measurements received from a plurality of pods are analyzed by the processing system which may employ triangulation calculations to estimate the location of a ball strike, as opposed to merely its distance to the target.

It is therefore an object of the present invention to provide a golf ranging system which is inexpensive to manufacture and readily introduced into existing golf ranges without substantial cost or modification.

It is an additional object of the present invention to provide a golf ranging system which can be easily moved from one location to another within a golf range.

It is still another object of the present invention to provide golfers with increased enjoyment and instruction while training at golf ranges.

To use another and more specific objects and advantages of the invention will be apparent to those skilled in the art from the following detailed description taken in conjunction with the drawings.

### BRIEF DESCRIPTION OF THE DRAWINGS

FIG. 1 is a perspective view of a pod for use with the golf ranging system of the present invention;

FIG. 2 is a perspective view illustrating an electronic t-stand for use with the automated ranging system of the present invention;

FIG. 3 is a perspective view of a golf ranging system of the present invention;

FIG. 4 is a graph illustrating amplitude measurements of the sound of a golf ball impacting a golf range;

FIG. 5 is a flow chart illustrating initial filtering steps conducted in connection with a processor's receipt of the sound of a golf ball impacting a golf range;

FIG. 6 is a flow chart illustrating a processor's receipt and modification of the sound of a golf ball striking a golf range; and

FIG. 7 is a flow chart illustrating analysis performed by the processor of the sound of a golf ball impacting a golf range in order for perform an estimate as to its distance to a target.

### DETAILED DESCRIPTION OF THE INVENTION

While the present invention is susceptible in embodiment in various forms, as shown in the drawings, hereinafter will be described the presently preferred embodiment of the invention with the understanding that the present disclosure is to be considered as an exemplification of the invention and it is not intended to limit the invention to the specific embodiments illustrated.

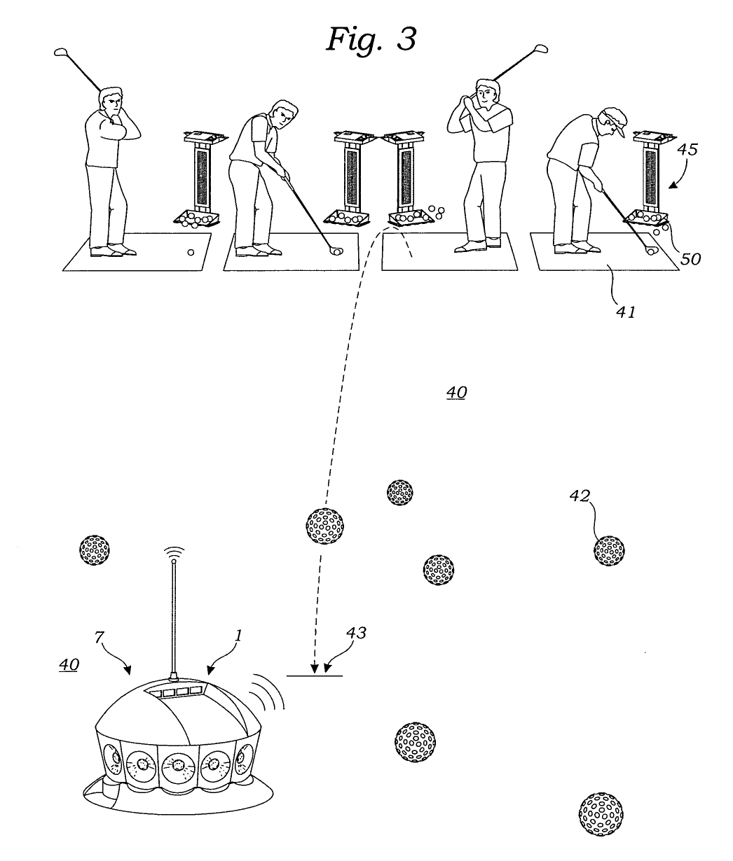

The present invention is directed to an automated golf ranging system which is particularly useful for retrofitting existing passive golf ranges. As shown in FIG. 3, a typical golf range 40 includes a t-box 45 wherein golfers utilize golf clubs to strike golf balls. A t-box typically include a mat 41 upon which a golfer stands and a hopper 50 for storing golf balls. The golf range 40 includes an expansive area, typically covered with grass, toward which golfer's aim their golf balls. In addition, the golf range may include sand traps which golfer's will attempt to avoid, and targets to which golfer's will aim their golf balls. Typically the targets will include traditional flag sticks which are found at a golf green.

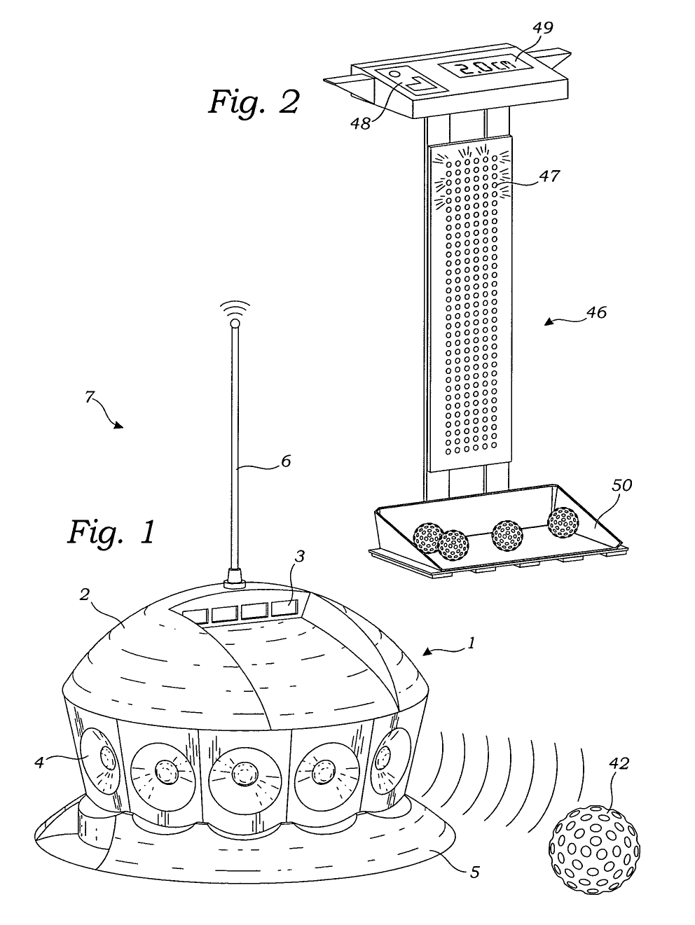

With reference to FIGS. 1-3, the automated ranging system of the present invention includes a pod 1 which is placed in the expansive area of the golf range. The pods are preferably placed in close proximity to the targets which are placed about the golf range. Alternatively, as shown in FIGS. 3, the pods may function as the target. Though not shown, to this end the pod may include a flag positioned atop a flag stick which is visually conspicuous to golfers at the range t-boxes.

The pod includes one or more microphones 4 for receiving the sound of a golf ball impacting the golf range. Where the pod includes a single microphone 4, preferably the microphone is omnidirectional in nature. However, where the pod includes a plurality of microphones, preferably the microphones 4 are directional microphones having cone receivers. In the preferred embodiment, the pod includes twelve microphones positioned every 30 degrees around the pod's housing 2. Moreover, preferably the microphones are directional to include a spread of at least 30 degrees for receiving sounds occurring from all directions around the pod.

The pod of the present invention further includes a power source and processor for determining the distance between a golf ball impact and a target. The power source can take various forms as can be determined by those skilled in the art. For example, the power source may simply be an electrical cord which extends to a 120 volt outlet supplied by a traditional power grid. However, in a preferred embodiment, the pod's power source takes the form of one or more mobile batteries which are carried within the pod's housing 2. In still an alternative embodiment, the power source takes the form of batteries connected to solar cells which recharge the batteries as sunshine permits.

It is also preferred that the sound processor be carried within the pod's housing. However, the processor may be positioned exterior to the pod such as within a nearby golf clubhouse or within a golf pro shop. As illustrated in FIGS. 1-7, sounds received by the microphones 4 are transmitted to the processor for modification, filtration and analysis to determine an estimate as to the distance between a golf ball impacting the golf range and the golfer's target 7. The processor converts the audio signals into electrical sound signals which undergo amplification and further modification and filtration before being analyzed by the processor. Initially, the processor removes sounds at frequency ranges below about 25 Hz. and above 250 Hz. In addition, the processor removes audio sounds having a length of less than 0.005 seconds and greater than 0.250 seconds. The processor may perform these filtration steps by various methods know to those skilled in the art including the use of both hardware and/or software techniques.

The ranging system works by analyzing the amplitude of the input sound signals whose magnitude is inversely representative of the distance of the ball striking the golf range to the target. In other words, the greater the amplitude of the golf ball striking the range, the less the distance between the impact and target.

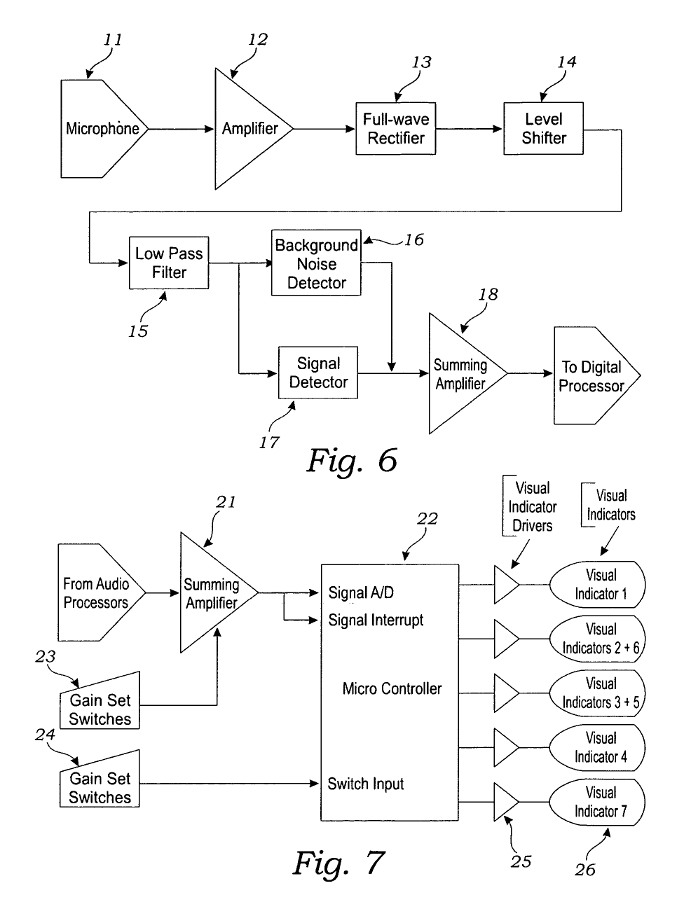

With reference to FIG. 6, the sound of the golf ball striking the range is received by microphone 11. The sound is then converted by the microphone into an electrical sound signal which is amplified by amplifier 12 and fully rectified by rectifier circuit 13. This produces a signal having a magnitude which is always in the positive quadrant. The sound signals are further processed by level shifting the signal through a level shifter 14 so that the signal is a ground of reference for no signal conditions. Furthermore, the sound signal is filtered through filtering circuit 15 to remove unwanted frequencies. The filtered sound signal is then received by the background noise detector 16 and signal detector 17. The sound signals from each detector are then summed by a summing amplifier 18 to produce signals occurring between the ground reference noise level and a maximum signal level.

Preferably, the sound received from each of the plurality of microphones proceeds through modification and filtration as illustrated in FIG. 6. Thereafter, each signal received from the plurality of microphones is then summed together within a digital processing circuit illustrated in FIG. 7. To this end, the audio signals from the microphones 4 are summed together by an additional summing amplifier 21 and then converted to digital by an analog to digital converter 22. The micro-controller 22 may include signal interrupts which are triggered whenever the audio signal exceeds a predetermined level. In addition, it is preferred that the processor include adjustable gain set switches 23 and 24 to compensate for different installation conditions and desired sensitivity for processing the audio signal.

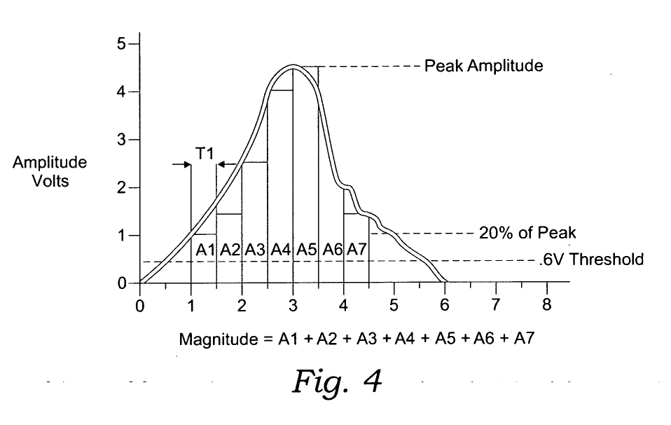

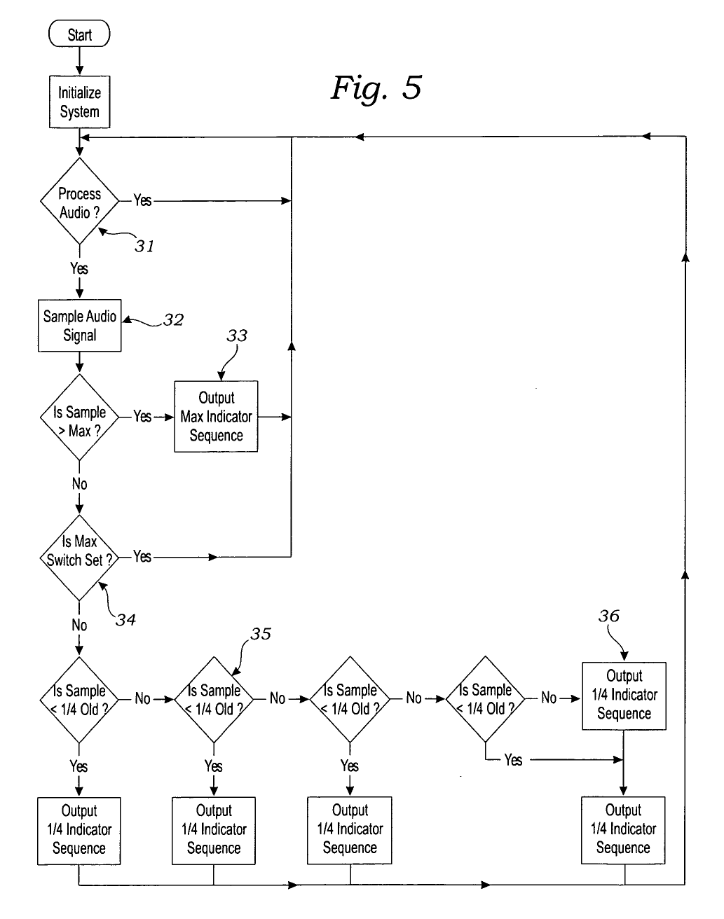

With reference to FIGS. 4 and 5, within the micro controller 22, analysis is performed to determine the amplitude of the sound produced by golf balls impacting the golf range. With reference particularly to FIG. 5, when a signal exceeds a threshold level from summing amplifier 21, the system performs an audio signal filtration step 31 to determine the time period for the sounds produced. If acceptable, the signals are forwarded for sampling by the audio signal circuit 32 to determine the sound's characteristics, including amplitude peak.

The sampled signal is then evaluated to determine if the signal has exceeded a predetermined maximum level. If the maximum level has been exceeded, a maximum output sequence 33 is initiated which results in continued analysis of the sound received. If the maximum sound is not exceeded, the sampled signal is evaluated at sequencing step 35 to determine the signal's amplitude in comparison to previous measurements. For example, if the sampled signal exceeds the previous sampled signals, then the newly sampled signal level is stored as the previous old samples signal max 36 to establish a new baseline for future comparisons.

With reference particularly to FIG. 4, the amplitude measurements reflected in the flow chart of FIG. 5 preferably incorporates time duration of the sound of a golf ball landing on the range surface. To this end, the processor periodically takes amplitude measurements at the rapid sample frequency rate T1 of every 0.5 milliseconds. The audio signal have been converted to volts, which as understood by those skilled in the art, will vary greatly due to the characteristics of the amplifiers employed. For simplicity, FIG. 4 illustrates a typical golf ball impact on a golf range producing a sound which has proceeded through amplifier and filtration circuits to produce an electronic sound signal having a peak of approximately 4.5 volts. Background noise, which as illustrated produces a 0.6 volt threshold, is removed from consideration. For greatest accuracy, each of the amplitude measurements taken at 0.5 millisecond intervals are summed for consideration by the processor in estimating distance between impact and target. The summing of the amplitude measurements may include first multiplying each amplitude measurement by the time period between readings. In other words, as shown in FIG. 4, in a preferred embodiment the area A1-A7, representing an approximation of the integral formed by the audio signal with respect to time, is analyzed to estimate the distance between golf ball impact and target. In a preferred embodiment, measurements are not considered prior to or subsequent to the sound achieving 20% of peak amplitude. The derivative of sound amplitude relative to time (ΔA/Δt) may also be considered by the processor in determining the distance between ball impact and the target.

Once the processor has estimated the distance between the target and golf ball impact, this information is forwarded to a visual or audio indicator for communicating to golfers the estimated distance between the target and golf ball impact. The visual or audio indicator may take any of numerous forms known to those skilled in the art. For example, as shown in FIG. 1 and FIG. 3, the indicator may take the form of one or more lights 3 formed on the exterior of the pod 1. Based upon the flashing of the lights or color displayed, golfers can determine the approximate distance between impact and target. In an alternative embodiment, the distance is transmitted by an RF antennae 6 to a t-stand 46 located in the t-box. This t-stand may take various forms such as the upright construction shown in FIGS. 2 and 3. The t-stand may include flashing lights 47 or may include a more complicated display 49 which displays distances, such as in the form of feet or meters. Alternatively, the display 49 may display subjective indicators such as a demonstrative expressions of “close to the pin”, “on the green”, “in the trees”, etc., etc. As shown in FIGS. 2 and 3, the t-stand 46 may include a golf ball hopper 50 for storing golf balls 42.

The golf ball ranging system of the present invention may be selectively modified for gaming applications or for golfers of different skill levels. For example, in a preferred embodiment the accuracy criteria for indicating subjective distance between a golf ball landing and target can be periodically, randomly or selectively changed. For example, pods may be established for novice golfers to indicate exceptional shots at 40 feet of the target while experts may require a shot within 20 feet or less before providing a visual or audio indication of an exceptional shot. Moreover, preferably the pod provides an indicator for telling golfers as to the skill level required of the pod. As an example only, visual indicators 3 may display a green color for novice golfers but a blue color for expert golfers. For added intrigue, the pods may randomly alter the skill level of the pod so as to entice golfers to utilize different pods at different times.

Many changes may be made without departing from the spirit and scope of the invention. For example, the pod 1 may be placed on wheels, and indeed can be motorized to randomly move about a golf range. Such movement may be predetermined or random and may be triggered based of various criteria, such as the targeting system encountering a high volume of balls impacting in its very near vicinity. Moreover, the drawings illustrate a relatively large structure for the pod. However, it is envisioned that the pods be hardly noticeable to the golfer at the t-box. Thus, the invention may be embodied in other forms and for other applications without departing from the essential characteristics of the invention.

Having described my invention in such terms to enable those skilled in the art to make and use it, and having identified the presently preferred embodiment thereof, we

1. A golf ranging system comprising:
a target positioned in proximity to a surface upon which golf balls can impact;
one or more microphones for receiving the sound of a golf ball impacting said surface;
a processor for measuring the amplitude of the sound of a golf ball impacting said surface; said processor also analyzing the amplitude of the sound of a golf ball impact said surface to provide an estimate as to the distance between said target and a golf ball impact; and
a visual or audio indicator for indicating the estimated distance between said target and a golf ball impact.

2. The golf ranging system of claim 1 wherein said processor filters out ambient background noise when analyzing the amplitude of the sound of a golf ball impacting said surface to provide an estimate as to the distance between said target and a golf ball impact.

3. The golf ranging system of claim 1 wherein said processor measures time duration of the sound of a golf ball impacting said surface, and said processor analyzes the amplitude of sound over a period of time to provide a plurality amplitude measurements, said plurality of amplitude measurements being analyzed by said processor to provide an estimate as to the distance between said target and a golf ball impact.

4. The golf ranging system of claim 3 wherein said processor sums said amplitude measurements to provide an estimate as to the distance between said target and a golf ball impact.

5. The golf ranging system of claim 3 wherein said processor analyzes the amplitude and time duration of the sound of a golf ball impact said surface includes one or more calculations of the change in sound amplitude over time (ΔA/Δt) to provide an estimate as to the distance between said target and a golf ball impact.

6. The golf ranging system of claim 1 wherein said processor includes a band-pass filter for removing sounds considered by the processor in estimating the distance between said target and a golf ball impact.

7. The golf ranging system of claim 6 wherein said band-pass filter removes sound of less than about 20 Hz and above about 200 Hz.

8. The golf ranging system of claim 1 wherein said processor includes a timing filter for removing sounds of predetermined lengths in estimating the distance between said target and a golf ball impact.

9. The golf ranging system of claim 8 wherein said timing filter removes sounds of less than about 0.005 seconds and greater than about 0.250 seconds.

10. The golf ranging system of claim 1 wherein said microphones include a plurality of microphones which produces a plurality of sound signals upon a golf ball impacting said surface, and said plurality of sound signals are summed prior to the processor estimating the distance between said target and a golf ball impact.

11. A method of estimating the distance between the impact of a golf ball upon a surface and a target, the method comprising the steps of:
providing a target positioned in proximity to a surface upon which golf balls can impact;
providing one or more microphones for receiving the sound of a golf ball impact said surface, a processor for measuring the amplitude of the sound of a golf ball impact said surface with said processor also analyzing the amplitude of the sound of a golf ball impacting said surface to provide an estimate as to the distance between said target and a golf ball impact, and a visual or audio indicator for indicating the estimated distance between said target and a golf ball impact;
striking a golf ball so as to impact said surface;
receiving the sound of the golf ball impacting said surface by the one or more microphones;
measuring the amplitude of the sound of the golf ball impacting said surface;
analyzing the amplitude of the sound of a golf ball impacting said surface to provide an estimate as to the distance between said target and the golf ball impact; and
providing a visual or audio indication of the estimated distance between said target and the golf ball impact.

12. The method of estimating the distance between the impact of a golf ball and a target of claim 11 further comprising the step of filtering out ambient background noise when analyzing the amplitude of the sound of a golf ball impacting said surface.

13. The method of estimating the distance between the impact of a golf ball and a target of claim 11 further comprising the steps of:
measuring the amplitude of sound over a period of time to provide a plurality amplitude measurements, and
analyzing the amplitude measurements to provide an estimate as to the distance between said target and said golf ball impact.

14. The method of estimating the distance between the impact of a golf ball and a target of claim 13 wherein said step of analyzing the amplitude measurements includes summing the amplitude measurements to provide an estimate as to the distance between said target and said golf ball impact.

15. The method of estimating the distance between the impact of a golf ball and a target of claim 13 wherein said step of analyzing the amplitude and time duration of the sound of a golf ball impacting said surface includes one or more calculations of the change in sound amplitude over time (ΔA/Δt) to provide an estimate as to the distance between said target and said golf ball impact.

16. The method of estimating the distance between the impact of a golf ball and a target of claim 11 further comprising the step of band-pass filtering out of sounds considered by the processor in estimating the distance between said target and said golf ball impact.

17. The method of estimating the distance between the impact of a golf ball and a target of claim 16 wherein said band-pass filtering removes sound of less than about 20 Hz and above about 200 Hz.

18. The method of estimating the distance between the impact of a golf ball and a target of claim 11 further comprising the step of removing sounds of predetermined lengths in estimating the distance between said target and said golf ball impact.

19. The method of estimating the distance between the impact of a golf ball and a target of claim 18 wherein said step of removing sounds removes sounds of less than about 0.005 seconds and greater than about 0.250 seconds.

20. The method of estimating the distance between the impact of a golf ball and a target of claim 11 wherein said microphones include a plurality of microphones which produces a plurality of sound signals upon a golf ball impacting said surface, and the steps further comprise the step of summing the sound signals prior to the processor estimating the distance between said target and said golf ball impact.

21. The method of estimating the distance between the impact of a golf ball and a target of claim 11 wherein the visual or audio indication of the estimated distance between the target and the golf ball impact is provided in the form of subjective feedback which can be altered to provide a golf ranging system having a plurality of skill levels, and the method of estimating the distance between the impact of a golf ball and a target further comprises the step randomly altering the subjective feedback and skill levels to provide randomly changing subjective feedback provided to the golfer.
